(19) United States
(12) Patent Application Publication
(10) Pub. No.: US 2025/0368132 A1
(43) Pub. Date: Dec. 4, 2025

(54) SIDE-VIEW MIRROR ASSEMBLY OF A VEHICLE

(71) Applicant: CHUNG-LIANG HUNG, NEW TAIPEI (TW)

(72) Inventor: CHUNG-LIANG HUNG, NEW TAIPEI (TW)

(21) Appl. No.: 18/675,170

(22) Filed: May 28, 2024

(51) Int. Cl. B60R 1/076

(52) U.S. Cl. CPC B60R 1/076

(57) ABSTRACT

A side-view mirror assembly is provided for a vehicle. The side-view mirror assembly includes a panel, a carrier and a side-mirror. The panel is attached to the vehicle. The carrier is movably connected to the panel, and includes a collar. The side-view mirror assembly includes an axle inserted in the collar. When the side-view mirror is hit, the side-view mirror is allowed to translate on the panel.

### BACKGROUND OF INVENTION

### 1. Field of Invention

The present invention relates to a vehicle and, more particularly, to a side-view mirror assembly of a vehicle.

### 2. Related Prior Art

A vehicle such a sedan is equipped with at least one mirror to enable a driver to see vehicles approaching from the rear without having to turn his or her head.

A typical sedan is provided with a rear-view mirror and two side-view mirrors. The rear-view mirror is located in the sedan. The side-view mirrors are located on two opposite sides of the sedan. It is much more likely that the side-view mirrors be hit than the rear-view mirror. In fact, it is inevitable that the side-view mirrors be hit from time to time.

To protect the side-view mirrors from grave damages, the side-view mirrors are pivotably connected to the sedan. When any of the side-view mirrors is hit, it is allowed to pivot relative to the sedan so that it is unlikely to be broken or removed from the sedan.

However, sometimes, a hit on a side-view mirror is too fierce, the pivoting of the side-mirror is not enough to buffer. Hence, the side-view mirror is damaged or removed from the vehicle.

The present invention is therefore intended to obviate or at least alleviate the problems encountered in the prior art.

### SUMMARY OF INVENTION

It is the primary objective of the present invention to provide a vehicle with a side-view mirror assembly.

To achieve the foregoing objective, the side-view mirror assembly includes a panel attached to the vehicle, a carrier and a side-mirror. The carrier is movably connected to the panel, and includes a collar. The side-view mirror assembly includes an axle inserted in the collar. When the side-view mirror is hit, the side-view mirror is allowed to translate on the panel.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a side-view mirror assembly according to the preferred embodiment of the present invention;

FIG. 2 is an exploded partial view of the side-view mirror assembly shown in FIG. 1;

FIG. 3 is another exploded partial view of the side-view mirror assembly shown in FIG. 1;

FIG. 4 is a cross-sectional view of the side-view mirror assembly shown in FIG. 1;

FIG. 5 is a side view of a car equipped with the side-view mirror assembly shown in FIG. 1; and

FIG. 6 is a perspective view of a motorcycle equipped with two side-view mirror assemblies as shown in FIG. 1.

### DETAILED DESCRIPTION OF PREFERRED EMBODIMENT

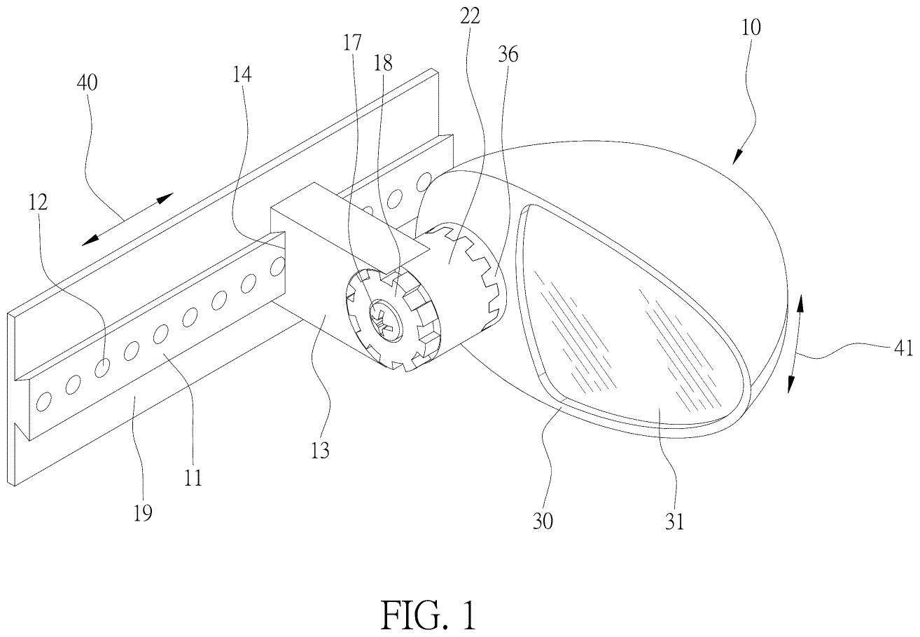

Referring to FIG. 1, a side-view mirror assembly 10 includes a side-view mirror, a buffer unit and a pivotal unit according to the preferred embodiment of the present invention. The buffer unit allows the side-view mirror to translate as indicated by arrow heads 40 when the side-view mirror is hit, thereby buffering the side-view mirror. The pivotal unit allows the side-view mirror to pivot as indicated by arrow heads 41 so that the side-view mirror can be located at any angle desired by a user.

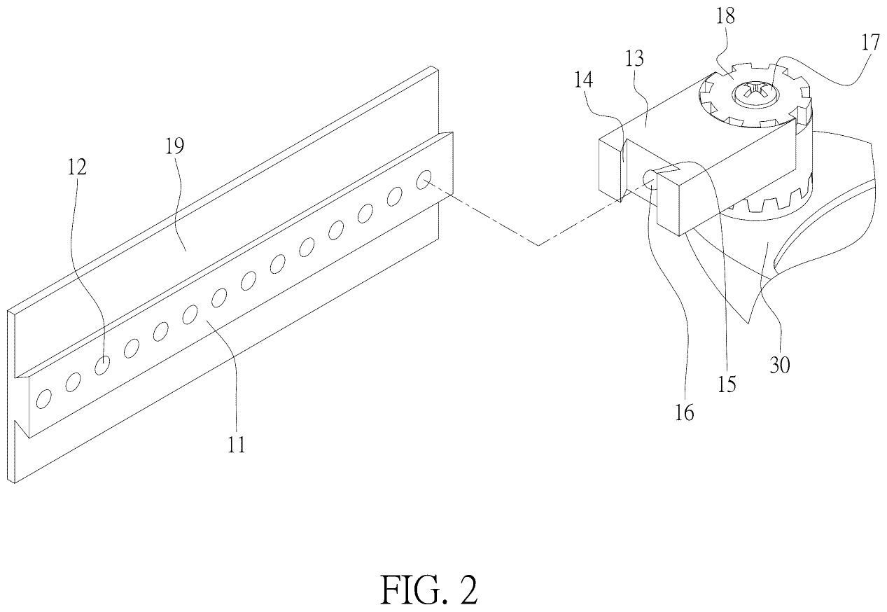

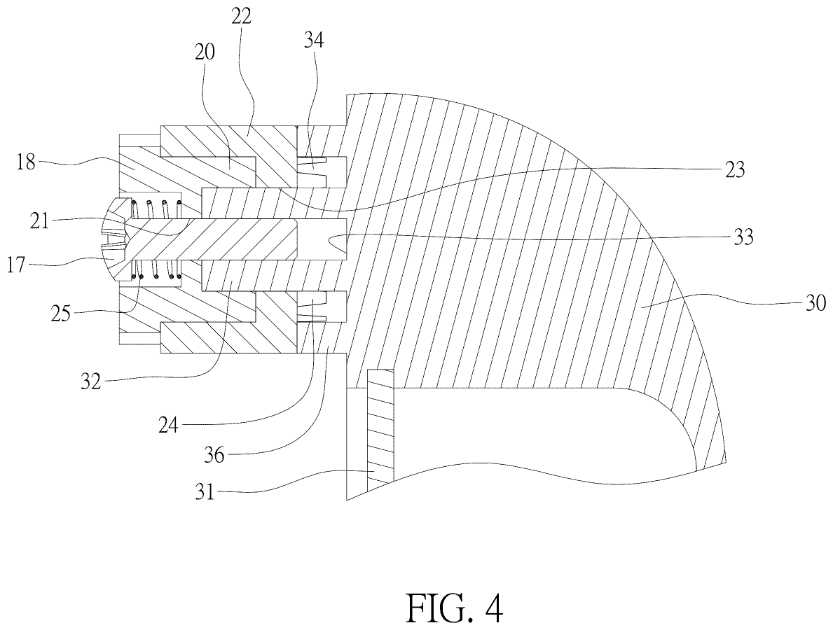

Referring to FIGS. 2 through 4, the side-view mirror includes a mirror 31 protectively located in a shell 30. The shell 30 is preferably made of plastics by injection molding. Although not shown, an electric mechanism is located in the shell 30 to adjust the orientation of the mirror 31 relative to the shell 30.

The pivotal unit includes an axle 32, a collar 22, a disc 18 and a screw 17. The axle 32 extends from the shell 30. The axle 32 is inserted in a large section of a stepped aperture 23 cut in the collar 22. The shell 30 is located on a side of the collar 22. The disc 18 is located on an opposite side of the collar 22. The screw 17 is inserted in a screw hole 33 cut in the axle 32. A head of the screw 17 is located on the disc 18. Thus, the shell 30 is pivotable relative to the collar 22.

To retain the shell 30 at a desired angle relative to the collar 22, the pivotal unit includes teeth 34 extending from a ring 36 extending from the shell 30 and teeth 24 extending from the collar 22. The teeth 34 are separated from one another by valleys 35. The teeth 24 are separated from one another by valleys 26. The teeth 24 are located in the valleys 35 and the teeth 34 are located in the valleys 26 to keep the shell 30 at a desired one of multiple angles relative to the collar 22. The ring 36 extends concentrically around the axle 32.

Preferably, a tube 20 coaxially protects from the disc 18. The tube 20 is formed with an internal flange 21. The tube 20 is inserted in a small section of the stepped aperture 23 of the collar 22. The axle 32 extends in the tube 20. Preferably, the axle 32 includes a cylindrical (or “circular”) external face and the tube 20 includes a cylindrical (or “circular”) internal face so that the axle 32 is rotatable relative to the tube 20. Alternately, the axle 32 is formed with a polygonal external face and the tube 20 is formed with a polygonal internal face so that the axle 32 is not rotatable relative to the tube 20.

To facilitate changing the angle of the shell 30 relative to the collar 22, a spring 25 is compressed between the head of the screw 17 and the internal flange 21 (or a portion of the disc 18). The spring 25 tends to bias the ring 36 against the collar 22, thereby elastically keeping the teeth 34 engaged with the teeth 24, i.e., retaining the shell 30 at a desired one of multiple angles relative to the collar 22 The spring 25 however allows the ring 36 to be moved away from the collar 22, thereby allowing the teeth 34 to be disengaged from the teeth 24, i.e., allowing the angle of the shell 30 relative to the collar 22 to be changed.

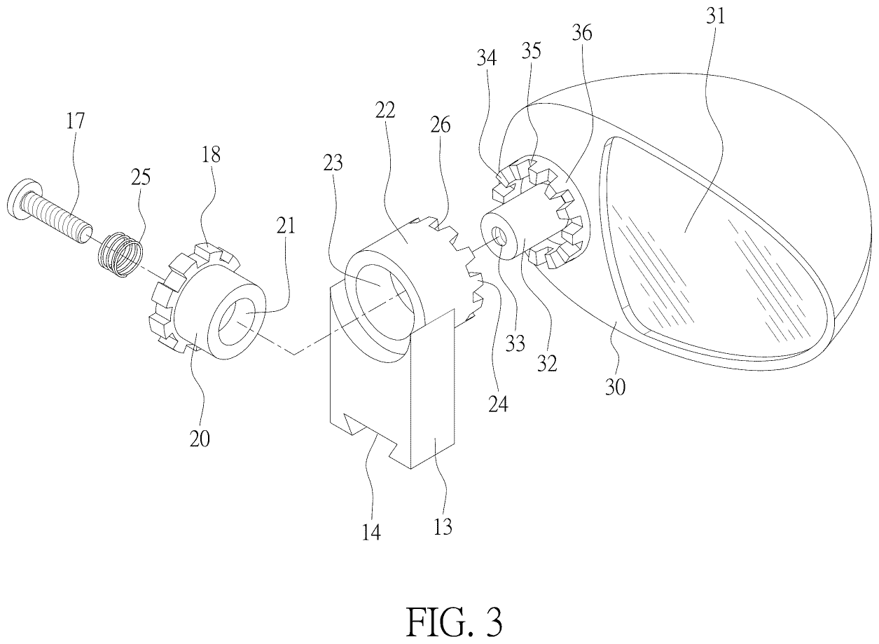

Referring to FIGS. 2 and 3, the buffer unit includes a carrier 13 connected to the collar 22 and a panel 19 for movably supporting the carrier 13. The panel 19 is formed with a dovetail 11. The carrier 13 is formed with a dovetail-type mortise 14 for receiving the dovetail 11 to movably support the carrier 13 on the panel 19.

To keep the carrier 13 in position on the panel 19, the dovetail 11 is formed with multiple bores 12 and the carrier 13 is provided with a spring-biased ball 16 for entering a desired one of the bores 12 to elastically keep the carrier 13 in a desired one of multiple positions relative to the panel 19. The carrier 13 is formed with a recess 15 for receiving a portion of the spring-biased ball 16. The recess 15 is located in the dovetail-type mortise 14.

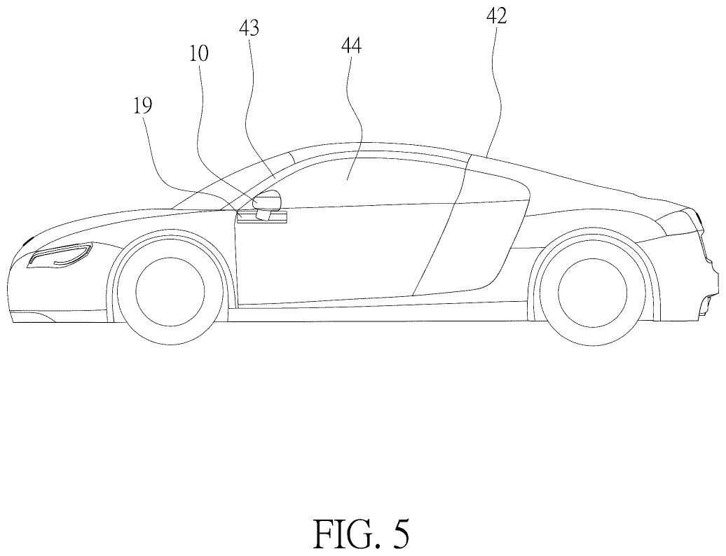

Referring to FIG. 5, the side-view mirror assembly is used on a car 42 for example. To this end, the panel 19 of the buffer unit is attached to a door (not numbered) of the car 42 by welding or adhesion. The panel 19 is located near a pillar 43 and a window 44 of the car 42. Thus, a driver can look into the mirror 31 of the side-view mirror assembly through the window 44 to observe vehicles approaching from the rear.

As mentioned above, the pivotal unit allow the change of the angle of the side-view mirror relative to the panel 19. Preferably, the side-view mirror is located in a relatively vertical position (FIG. 1) when the car 42 is parked. Preferably, the side-view mirror is located in a relatively horizontal position (FIG. 5) when the car 42 is driven.

When the side-view mirror is hit, the side-view mirror is allowed to move relative to the door of the car 42 due to the use of the buffer unit. The friction between the carrier 13 and the combination of the dovetail 11 with the panel 19 consumes energy exerted on the side-view mirror. Hence, the spring-biased ball 16 is moved to a new one of the bores 12 from the desired one of the bores 12. Later, the driver is allowed to return the side-view mirror to the desired position, i.e., return the spring-biased ball 16 to the desired one of the bores 12.

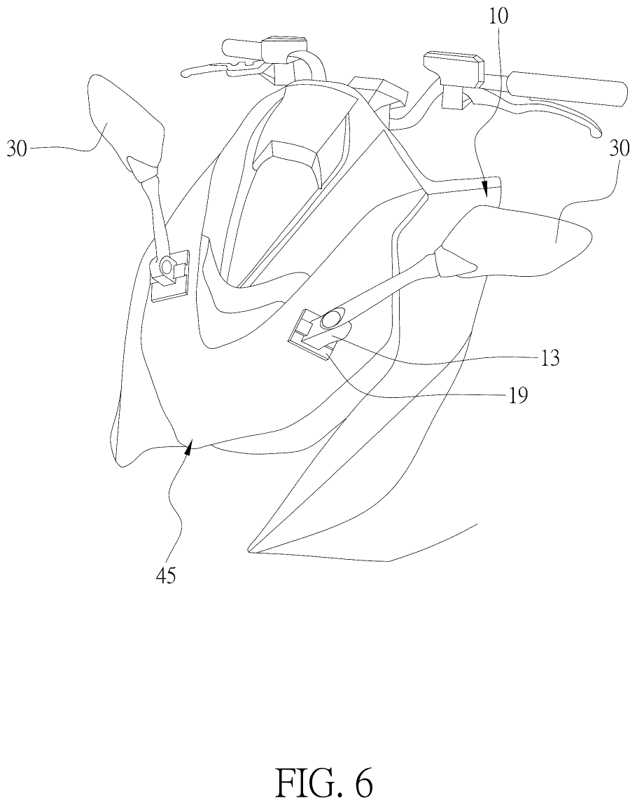

Referring to FIG. 6, the panel 19 of the side-view mirror assembly is connected to a motorcycle 45.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A side-view mirror assembly comprising:
a panel;
a carrier movably connected to the panel, wherein the carrier comprises a collar; and
a side-view mirror assembly comprises an axle inserted in the collar.

2. The side-view mirror assembly according to claim 1, further comprising:
a dovetail-type mortise cut in the carrier;
a dovetail formed on the panel, wherein the dovetail extends throughout the dovetail-type mortise so that the carrier is movable relative to the panel.

3. The side-view mirror assembly according to claim 2, further comprising:
a series of bores cut in the dovetail;
a spring-biased ball connected to the carrier, wherein the spring-biased ball insertable in a desired one of the bores.

4. The side-view mirror assembly according to claim 1, further comprising:
teeth extending from the collar; and
teeth extending from the side-view mirror around the axle, wherein the teeth of the collar are engageable with the teeth of the side-view mirror.

5. The side-view mirror assembly according to claim 4, further comprising:
a disc located against the collar;
a tube extending into the collar from the disc, wherein the axle is inserted in the tube;
a screw inserted in the axle; and
a spring compressed between a portion of the disc and a head of the screw, thereby biasing the side-view mirror toward the collar to keep the teeth of the side-view mirror engaged with the teeth of the collar.

6. The side-view mirror assembly according to claim 5, wherein the spring is a helical spring.

7. The side-view mirror assembly according to claim 4, wherein the side-view mirror further comprises a ring, wherein the teeth extend from the ring.

8. The side-view mirror assembly according to claim 1, further comprising:
a disc located against the collar;
a tube extending into the collar from the disc, wherein the axle is inserted in the tube;
a screw inserted in the axle; and
a spring compressed between a portion of the disc and a head of the screw, thereby biasing the side-view mirror toward the collar.

9. The side-view mirror assembly according to claim 8, wherein the spring is a helical spring.
